(19) United States
(12) Patent Application Publication
(10) Pub. No.: US 2026/0335907 A1
(43) Pub. Date: Oct. 29, 2026

(54) NOZZLE FOR GASEOUS MEDIA AND METHOD FOR OPERATING A NOZZLE

(71) Applicant: Lechler GmbH, Metzingen (DE)

(72) Inventor: Nathan ENGELS, Reutlingen (DE)

(21) Appl. No.: 19/660,402

(22) Filed: Apr. 28, 2026

(30) Foreign Application Priority Data
Apr. 29, 2025 (DE) 102025116515.7

(51) Int. Cl. B05B 1/00

(52) U.S. Cl. CPC B05B 1/005

(57) ABSTRACT

A nozzle for gaseous media, in particular a compressed air nozzle. The nozzle has a housing, an inlet and at least one outlet opening, wherein a border of the outlet opening is defined by an intersection of an outlet portion of an outlet duct with a portion of the outer wall of the housing surrounding the outlet opening. The outlet duct is connected in terms of flow to the inlet, and the border of the outlet opening defines the beginning and end of the outlet portion, and the border of the outlet opening spans a non-planar outlet surface.

### CROSS-REFERENCE TO RELATED APPLICATION

This claims priority from German Application No. 102025116515.7, filed Apr. 29, 2025, the disclosure of which is hereby incorporated by reference in its entirety.

### TECHNICAL FIELD

The invention relates to a nozzle for gaseous media, in particular a compressed air nozzle, having a housing, an inlet, at least one outlet opening, wherein a border of the outlet opening is defined by an intersection of an outlet portion of an outlet duct with a portion of the outer wall of the housing surrounding the outlet opening, wherein the outlet duct is connected in terms of flow to the inlet, and wherein the border of the outlet opening defines the beginning and end of the outlet portion. The invention also relates to a method for operating a nozzle according to the invention.

### BACKGROUND AND SUMMARY

A compressed air nozzle having a housing, an inlet and numerous outlet openings is known from the German patent DE 24 13 614. The outlet openings are arranged next to one another in a straight line. The compressed air nozzle accordingly makes provision for a large number of individual nozzle ducts to be provided next to one another. The noise level of the nozzle is intended to be substantially lower than the noise level of a nozzle with a single outlet.

International laid-open application WO 2024/156604 A discloses a nozzle for gaseous media, in which a plurality of outlet openings are arranged next to one another, wherein the centre longitudinal axes of the outlet openings are inclined away from the centre longitudinal axis of the middle outlet opening more sharply from the centre towards the edge.

The invention is intended to improve a nozzle for gaseous media with regard to its blowing force and with regard to its noise level generated during operation.

A nozzle for gaseous media, in particular a compressed air nozzle, has a housing, an inlet and at least one outlet opening, wherein a border of the outlet opening is defined by an intersection of an outlet portion of an outlet duct with a portion of the outer wall of the housing surrounding the outlet opening, wherein the outlet duct is connected in terms of flow to the inlet, and wherein the border of the outlet opening defines the beginning and end of the outlet portion, wherein the border of the outlet opening spans a non-planar outlet surface.

The non-planar outlet surface causes the outlet jet to be widened by the expansion of the gaseous medium downstream of the outlet opening or even divided into at least two partial jets. The inventors have found that widening the jet or splitting the jet into at least two partial jets downstream of the outlet opening reduces noise without losing blowing force. The border of the outlet opening spans a non-planar outlet surface, wherein spanning a surface means that straight lines running perpendicular to the outflow direction are placed on in each case two opposite points of the border of the outlet opening. The sum or the connection of all of these parallel lines then defines the spanned outlet surface. The outlet surface can also be defined as a continuation of the housing shape which surrounds the outlet opening, wherein said continuation lies within the border of the outlet opening. A cross section of the outlet duct is preferably circular, with a circular cross section of the outlet duct not necessarily having to be provided within the scope of the invention.

In a development of the invention, at least five outlet openings are provided in the housing.

The provision of a plurality of outlet openings makes it possible to further reduce a noise level of the nozzle according to the invention during operation.

In a development of the invention, at least five of the outlet openings have the same diameter, and a distance between in each case two adjacent outlet openings from each other is a maximum of ten times the diameter of the outlet openings.

In this way, a compact nozzle is provided, a noise level can be reduced and a high blowing force can be realized.

In a development of the invention, the outlet surface is formed in the manner of a roof and is defined by means of a ridge line and two partial outlet surfaces, wherein the partial outlet surfaces start from the ridge line and are differently aligned at least in sections, and wherein the ridge line defines a maximum height (H) of the outlet portion between the start and end of the outlet portion.

In a development of the invention, the outlet surface is formed in the manner of a channel and is defined by means of a trough line and two partial outlet surfaces, wherein the partial outlet surfaces start from the trough line and are differently aligned at least in sections, and wherein the trough line defines a maximum depth of the outlet portion between the start and end of the outlet portion.

In a development of the invention, the outlet duct at the transition into the outlet portion has a free cross-sectional area arranged perpendicular to the flow direction, and the height (H) or depth (H) of the outlet portion is at least 15%, in particular at least 20%, in particular at least 25%, of the square root of the size of the cross-sectional area of the outlet duct.

In this way, a widening of the jet or even a splitting of the jet into at least two partial jets can be achieved downstream of the outlet opening. This results in a significant noise reduction without losing blowing force. If the height H or depth H of the outlet portion is at least 15% of the square root of the size of the cross-sectional area of the outlet duct, this results in an outlet surface differing to a comparatively strong degree from a planar surface. Such an outlet surface differing to a strong degree from a planar surface in turn causes a widening of the emerging jet or even a division of the emerging jet into at least two partial jets.

In a development of the invention, the outlet surface is curved.

For example, the outlet surface has been created by intersection of a circular outlet portion with a circular-cylindrical surface. This enables reliable operation of the nozzle, in particular a reliable widening of the emerging jet or a division of the emerging jet into at least two partial jets. In addition, the housing in the region surrounding the outlet opening is less sensitive, since, rather than sharp edges, only rounded portions are provided adjacent to the outlet opening.

In a development of the invention, the outlet surface forms a cutout of a convexly or concavely curved cylinder surface, in particular a circular-cylindrical surface.

In a development of the invention, the outlet surface consists of at least two planar partial outlet surfaces, wherein at least two of the partial outlet surfaces abut against one another at the ridge line or trough line and are arranged with respect to one another at an angle differing from 180°.

In a development of the invention, the outlet surface forms a cutout from a gable roof surface.

In a development of the invention, a ridge line of the gable roof surface forms part of a convexly rounded ridge surface.

The ridge thus does not form a sharp edge, but rather a rounded edge, such that the nozzle in the region surrounding the outlet opening is less sensitive to a shock load, since no tapered edges are provided in the region surrounding the outlet opening. Even if the outlet surface is in the form of a channel, a trough line can form part of a concavely rounded trough surface.

In a development of the invention, a plurality of outlet openings are arranged next to one another on an imaginary straight line.

In a development of the invention, the plurality of outlet surfaces are aligned with one another.

Even with a channel-like formation of the outlet surfaces, the plurality of outlet surfaces can be aligned with one another.

In a development of the invention, the ridge lines of the outlet surfaces are arranged parallel to one another and at the distance of the centre longitudinal axes of the outlet ducts.

Such an arrangement may be selected even with a channel-like formation of the outlet surface, with the trough lines of the outlet surfaces then being arranged parallel to one another and at the distance of the centre longitudinal axes of the outlet ducts.

Within the scope of the invention, a plurality of outlet openings may be arranged next to one another on an imaginary, curved line which lies within a plane. The curved line is not a circular line, but, for example, only forms a portion of a circular line. The curved line may also not form a portion of a circular line, but may assume different curvatures over its course. As seen in the flow direction from the inlet to the outlet openings, outer outlet openings may be set back in relation to outlet openings lying further inwards.

In a development of the invention, at least three outlet ducts are provided, wherein, as seen perpendicular to the outflow direction, an angle of the centre longitudinal axis of the outer outlet portions to the centre longitudinal axis of the middle outlet duct or of the middle outlet portion is greater than 0°, in particular less than 45°, in particular less than 30°.

In a development of the invention, at least five outlet ducts are provided, wherein, as seen perpendicular to the outflow direction, an angle of the centre longitudinal axes of the outer outlet portions to the centre longitudinal axis of the middle outlet duct or of the middle outlet portion increases.

As a result, the outlet portions are arranged in the manner of a fan.

In a development of the invention, a plurality of outlet openings lie on an imaginary circular line, which lies within a plane.

In this way, a compact design of the nozzle can be realized. The plane spanned by the imaginary circular line then expediently lies perpendicular to the outflow direction.

In a development of the invention, the at least one outlet duct, as seen in the flow direction from the inlet to the outlet opening, has a constant cross section, a decreasing cross section or a slightly expanding cross section.

Such a formation of the outlet duct makes it possible for the gas flow emerging from the outlet opening to be able to expand. This is not possible, for example, with what is referred to as a Laval nozzle, in which an outlet duct expands greatly over its course. With the nozzle according to the invention, the intention is for none of the plurality of outlet openings to operate as a Laval nozzle.

In a development of the invention, the outlet duct has a slightly expanding cross section, wherein a cross-sectional area of the outlet duct immediately before the transition of the outlet duct into the outlet portion is a maximum of 20% larger than a smallest cross-sectional area of the outlet duct.

Such a small expansion of the outlet duct by a maximum of 20% facilitates the removal from the mould when producing the nozzle according to the invention by means of plastics injection moulding. Nevertheless, the inventors have found that such a small expansion of the outlet duct still allows an expansion or widening of the gas jet emerging from the outlet opening.

In a development of the invention, the inlet, the outlet duct and the outlet opening are designed and arranged in such a way that, during supercritical operation of the nozzle at a positive pressure of 1 bar or more than 1 bar, the gas jet expands after passing through the outlet opening.

Downstream of the outlet opening, the gas jet is thus widened or even divided into at least two partial jets. The inventors expect that this effect of widening or even splitting it into a plurality of partial jets permits a considerable reduction in the noise level of the nozzle during operation.

In a development of the invention, a cross section of the outlet duct is circular.

In a development of the invention, a cross section of the outlet duct is oval, elliptical, polygonal, rectangular, square or hexagonal, wherein a maximum width and a maximum height of the outlet duct have, at maximum, a ratio of 1:5, in particular 1:3, in particular 1:2.

As a result, the outlet openings are not slot-shaped.

In a development of the invention, each outlet duct and each outlet opening are formed in an integral portion of the housing.

In this way, the outlet ducts and outlet openings can be manufactured with high precision, so that the desired properties of the nozzle can be reliably achieved.

In a method for operating a nozzle according to the invention, provision is made for the nozzle to be operated in the supercritical range at a positive pressure of the gaseous medium of 1 bar or more than 1 bar, such that the medium jet emerging from the at least one outlet opening widens after passing through the outlet opening.

Further features and advantages of the invention emerge from the description below of preferred embodiments of the invention in conjunction with the drawings. Individual features of the different embodiments illustrated in the drawings and described in the description may be combined with one another in any desired manner without going beyond the scope of the invention.

### BRIEF DESCRIPTION OF THE DRAWINGS

In the drawings:

FIG. 1 shows a view of a nozzle according to the invention according to a first embodiment obliquely from above;

FIG. 2 shows a view of the nozzle from FIG. 1 from the front;

FIG. 3 shows a view of the nozzle from FIG. 1 from above;

FIG. 4 shows an enlarged illustration of the detail Z from FIG. 2;

FIG. 5 shows a view of the sectional plane A-A in FIG. 3;

FIG. 6 shows a view of the sectional plane C-C in FIG. 5;

FIG. 7 shows an enlarged illustration of the detail Y from FIG. 6;

FIG. 8 shows an enlarged illustration of the detail X from FIG. 5;

FIG. 9 shows a view of a nozzle according to the invention according to a second embodiment;

FIG. 10 shows a side view of the nozzle from FIG. 9;

FIG. 11 shows a view of the sectional plane A-A in FIG. 10;

FIG. 12 shows an enlarged illustration of the detail G from FIG. 11;

FIG. 13 shows a view of a nozzle according to the invention according to a third embodiment obliquely from above;

FIG. 14 shows a front view of the nozzle from FIG. 13;

FIG. 15 shows a top view of the nozzle from FIG. 13;

FIG. 16 shows an enlarged illustration of the detail Z from FIG. 14;

FIG. 17 shows a view of the sectional plane A-A in FIG. 15;

FIG. 18 shows a view of the sectional plane C-C in FIG. 17;

FIG. 19 shows an enlarged illustration of the detail Y from FIG. 18;

FIG. 20 shows an enlarged illustration of the detail X from FIG. 17;

FIG. 21 shows a view of a nozzle according to the invention according to a fourth embodiment obliquely from above;

FIG. 22 shows a front view of the nozzle from FIG. 21;

FIG. 23 shows a partially sectioned top view of the nozzle from FIG. 21;

FIG. 24 shows an enlarged illustration of the detail A from FIG. 23;

FIG. 25 shows a schematic illustration of the formation of an outlet opening with a curved outlet surface by intersecting a circular outlet portion with an outer surface in the manner of a gable roof of a housing; and

FIG. 26 shows a schematic illustration of the formation of an outlet opening with a curved outlet surface by intersecting an outlet portion with a circular cross section with a channel-shaped outer surface of a housing.

### DETAILED DESCRIPTION

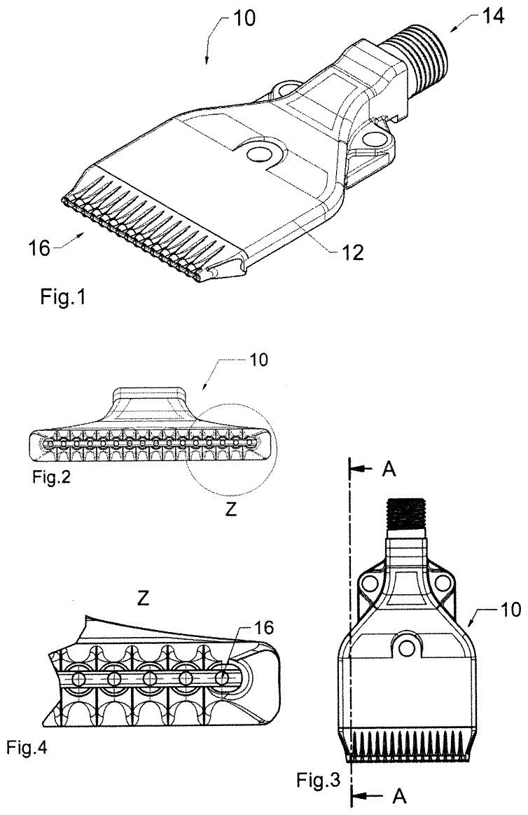

FIG. 1 shows a nozzle 10 according to the invention, which is designed as a compressed air nozzle. The compressed air nozzle 10 has a housing 12 with an inlet 14 and a total of sixteen outlet openings 16. The outlet openings 16 are arranged next to one another along an imaginary, straight line.

FIG. 2 shows a front view of the nozzle 10 from FIG. 1. It can be seen in FIG. 2 and in the enlarged illustration of the detail Z in FIG. 4 that outlet ducts leading to the outlet openings 16 each have a circular cross section.

FIG. 3 shows a top view of the nozzle 10 according to the invention from FIG. 1.

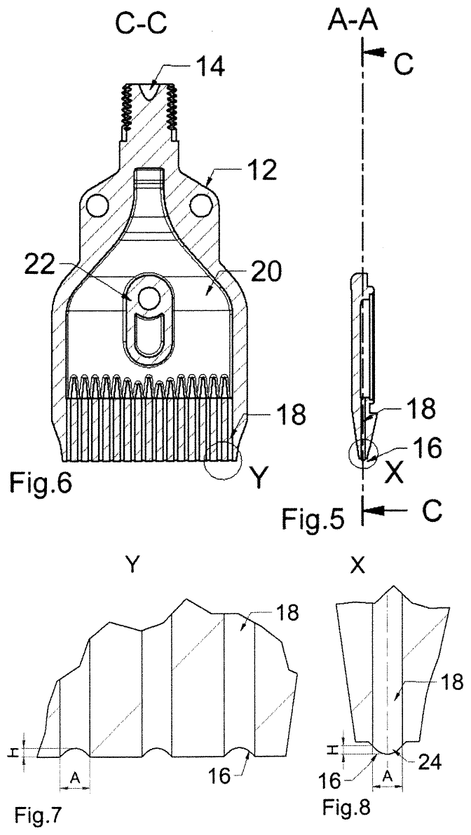

FIG. 5 shows a view of the sectional plane A-A in FIG. 3. The sectional plane A-A runs through the outlet duct 18 which is arranged on the left-hand side in FIG. 3 and lies the furthest outwards. It can already be seen in FIG. 5 that the outlet duct 18 runs rectilinearly and that the outlet opening 16 is formed by the intersection of the circular-cylindrical outlet duct 18 with the convexly curved housing surface in the region of the outlet opening 16.

FIG. 6 shows a view of the sectional plane C-C in FIG. 5. Upstream of the outlet ducts 18 running rectilinearly, a flow chamber 20 is arranged in the housing of the nozzle, from which all sixteen outlet ducts 18 emerge and which is connected in terms of flow to the inlet 14. Compressed air entering through the inlet into the housing 12 or another gaseous medium first of all enters the flow chamber 20 and is distributed from the flow chamber 20 to the individual outlet ducts 18. The flow chamber 20 has a centrally arranged strut 22, which ensures the stability of the housing. The housing 12 is advantageously constructed in two parts and, in the region of the column 22, the two housing halves can be supported against each other in the same manner as in the region of the edge of the housing.

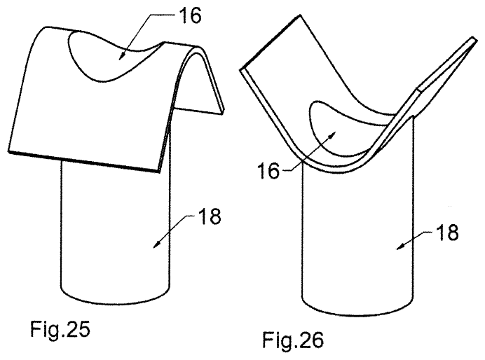

FIG. 7 shows an enlarged illustration of the detail Y in FIG. 6. It can be seen that the outlet opening 16 spans a curved outlet surface, the formation of which can be better seen with reference to FIG. 8. FIG. 8 shows an enlarged illustration of the detail X from FIG. 5. The outlet duct 18 has an outlet portion 24, the outlet portion 24 forming the end portion of the outlet duct 18 and being delimited by the border of the outlet opening 16. The outlet portion 24 is thus delimited upstream with respect to the rest of the outlet duct 18 by a circular cross section and downstream by the curved border of the outlet opening 16, which in turn spans the curved outlet surface. In the embodiment shown, the outlet surface is curved and is formed by the intersection of the circular outlet duct 18 with the curved, roof-like outer surface of the housing 12 in the region of the outlet opening 16; see the schematic illustration of FIG. 25.

When compressed air flows through the outlet duct 18 and enters the outlet portion 24, the curved outlet surface of the outlet opening 16 makes it possible for the emerging compressed air jet to widen immediately downstream of the outlet opening 16. The widening can also be brought about by the fact that the emerging gas jet is divided into at least two partial jets. The inventors have found that such a shaping of the outlet opening, so that it spans a non-planar and in particular curved outlet surface, and the resulting widening of the emerging gas jet causes a considerable reduction in the noise level of the emerging gas jet without losing blowing force.

The curvature of the outlet surface spanned by the border of the outlet opening 16 is determined by the height H of the outlet portion 24 and the diameter A of the outlet duct 18. The inventors have found that a particularly significant reduction in the noise level of the emerging gas jet can be achieved without losing blowing force if the height H is at least 15% of the square root of the size of the cross-sectional area of the outlet duct. As is known, the size of the cross-sectional area of the outlet duct in a cross-sectionally circular outlet duct 18 is calculated as the product of the number Pi with the square of the radius, the radius being half the diameter A. Advantageous embodiments of the invention are achieved when the height H of the outlet portion 24 is at least 15%, in particular at least 20%, in particular at least 25%, of the square root of the size of the cross-sectional area of the outlet duct 18.

If, according to an embodiment of the invention, the outlet duct 18 opens into a channel-like outer surface of the housing, see FIG. 26, an outlet opening the border of which also spans a curved outlet surface is also formed. Corresponding to the height H of the outlet portion 24, the depth H of the outlet portion is then defined such that it is at least 15%, in particular at least 20%, in particular at least 25%, of the square root of the size of the cross-sectional area of the outlet duct.

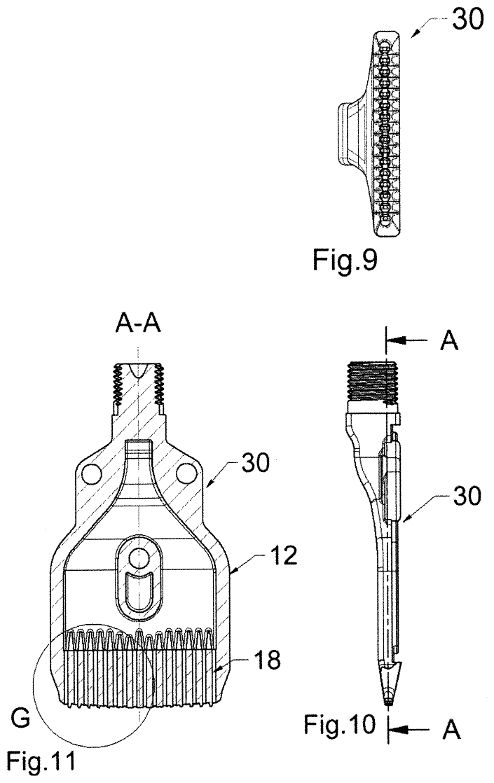

FIG. 9 shows a front view of a nozzle 30 according to the invention according to a second embodiment of the invention. The nozzle 30 is constructed similarly to the nozzle 10, which has already been explained with reference to FIGS. 1 to 8, and therefore only the differences of the nozzle 30 with respect to the nozzle 10 are explained.

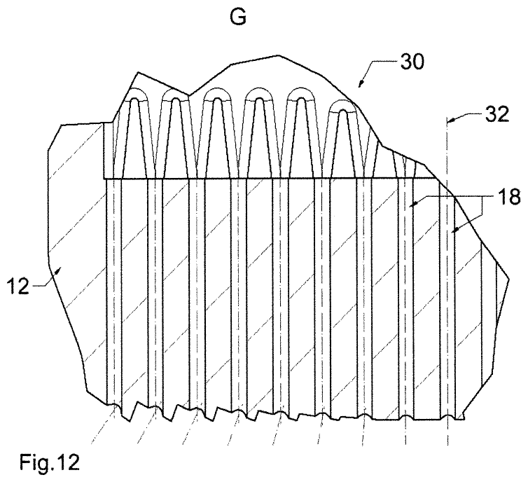

FIG. 10 shows a side view of the nozzle 30 of FIG. 9, and FIG. 11 shows a view of the sectional plane A-A in FIG. 10.

FIG. 11 shows that the outlet ducts 18 in the housing 12 of the nozzle 30 also run parallel to one another, but said outlet ducts open into differently aligned outer surfaces of the housing.

FIG. 12 shows an enlarged illustration of the detail G from FIG. 11. It can be seen that the two central outlet ducts 18, which are shown on the right in FIG. 12, open into a curved outer surface of the housing 12, the outer surface being arranged perpendicularly to the centre longitudinal axis of the two outlet ducts 18. The further the outlet ducts 18 lie on the outside, i.e. to the right of the two middle outlet ducts 18 in FIG. 12, the more the outer surface of the housing is inclined with respect to the central plane of the housing 32. The housing 12 of the nozzle 30 is mirror-symmetrical to the central plane 32. An angle enclosed by the centre longitudinal axes of the outlet openings with the centre longitudinal axes of the associated outlet ducts is thus exactly 0° at the two middle outlet ducts 18, since the centre longitudinal axes are aligned with one another, and rises to the outer sides of the housing, i.e. to the left in FIG. 12.

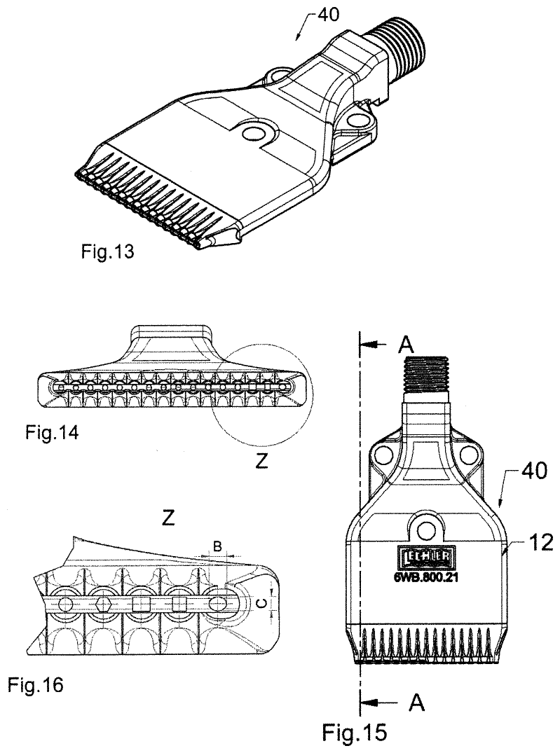

FIG. 13 shows a further nozzle 40 according to the invention according to a third embodiment of the invention. The nozzle 40 differs from the nozzle 10, which has already been explained with reference to FIGS. 1 to 8, only in the cross section of a part of the outlet ducts arranged on the right in FIG. 13 and with regard to an inclination of the outlet surfaces in another part of the outlet openings arranged on the left in FIG. 13. Only the differences between the nozzle 40 and the nozzle 10 are explained below.

The nozzle 40 has sixteen outlet openings, wherein the eight outlet ducts arranged on the left in FIG. 13 have a circular cross section, whereas the eight outlet ducts arranged on the right in FIG. 13 have a different cross section. FIG. 16 shows an enlarged illustration of the detail Z from FIG. 14.

In FIG. 16, the enlarged illustration of the detail Z from FIG. 14, a total of five outlet ducts can be seen. As seen from left to right, the outlet duct arranged on the far left in FIG. 16 has a circular cross section, the outlet duct, which is shown as second from the left, has a hexagonal cross section, the outlet duct arranged third from the left has a rectangular cross section, the outlet duct arranged fourth from the left has a square cross section and the outlet duct arranged on the far right has an elliptical cross section.

Within the scope of the invention, the cross section of the outlet ducts can be varied in almost any manner; in the case of a non-circular cross section of the outlet ducts, a maximum width and a maximum height of the outlet duct having, at maximum, a ratio of 1:5, in particular 1:3, in particular 1:2. The inventors have found that even in the case of a non-circular cross section of the outlet duct, the function according to the invention that the emerging gas jet widens downstream of the outlet opening can be achieved.

FIG. 15 shows a top view of the nozzle 40 from FIG. 13. It can be seen in FIG. 15 that the outer surface of the housing in the region of the eight outlet ducts arranged on the left side of the housing 12 is bevelled.

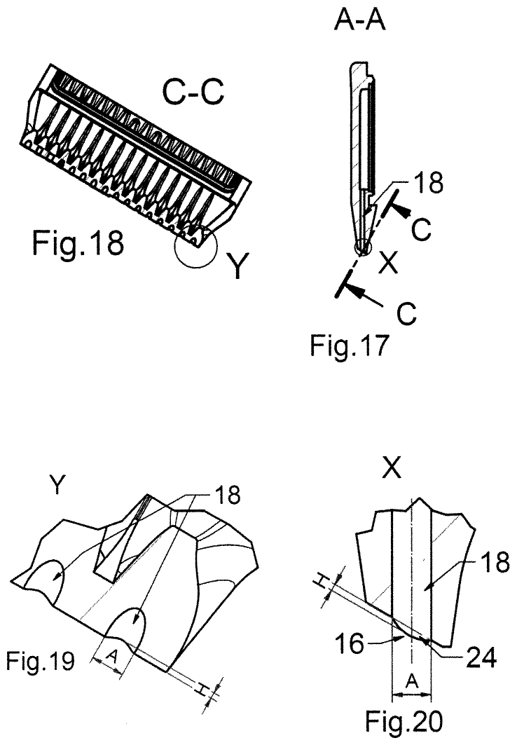

FIG. 17 shows a view of the sectional plane A-A in FIG. 15. FIG. 17 shows that the outer surface of the housing is bevelled with respect to a centre longitudinal axis of the outlet duct 18.

FIG. 20 shows the enlarged detail X from FIG. 17. It can be seen that the outlet opening 16 spans a curved outlet surface and that said outlet surface is defined by the outlet portion 24 with the height H and a diameter of the outlet duct A. Also in the case of the nozzle 40 of FIGS. 13 to 20, the height H of the outlet portion 24 is at least 15%, in particular at least 20%, in particular at least 25%, of the square root of the size of the cross-sectional area of the outlet duct 18.

FIG. 18 shows a view of the sectional plane C-C in FIG. 17, and FIG. 19 shows the enlarged detail Y from FIG. 18. According to FIG. 19, the sectional plane C-C intersects two outlet ducts 18 in the region of the outlet opening. FIG. 19 and FIG. 20 show that the outlet openings each span a curved outlet surface and that a height of the outlet portion 24 is H.

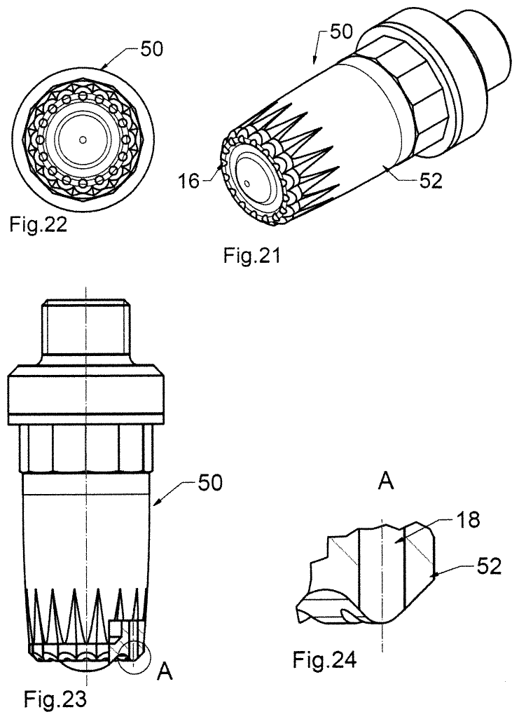

FIG. 21 shows a nozzle 50 according to the invention according to a fourth embodiment. The nozzle 50 has a housing 52 and a total of sixteen outlet openings 16. The outlet openings 16 each span a curved outlet surface and are arranged next to one another along an imaginary circular line; see also the front view in FIG. 22. The imaginary circular line spans a plane perpendicular to the outflow direction.

FIG. 23 shows a partially sectioned view of the nozzle 50. FIG. 24 shows an enlarged illustration of the detail A from FIG. 23. It can be seen that the outlet duct 18 opens at a convexly curved outer surface of the housing 52. As a result, the outlet opening has a curved border and spans a curved outlet surface. The outer surface in the region of the mouths of the outlet ducts 18 has an annular, rounded projection, and therefore all of the outlet openings 16 have an outlet portion with the same height H.

Also in the case of the nozzle 50, the emerging gas jet downstream of the outlet opening 16 will widen and possibly even split into at least two partial jets. Even the nozzle 50 according to the invention can thus produce a significantly reduced noise level in operation compared to conventional compressed air nozzles, with an unchanged or even improved blowing force.

FIG. 25 schematically shows the intersection of a circular outlet duct 18 with a roof-like outer surface of a housing.

FIG. 26 shows the intersection of a circular outlet duct 18 with a channel-shaped outer surface of a housing. The curved outlet surface, which is spanned by the outlet opening 16 in the embodiment according to FIG. 25 and in the embodiment according to FIG. 26, is identical, if the angles and the curvature of the partial surfaces of the outer surface of the housing are equal in amount and only different in terms of sign. Both in the embodiment of FIG. 25 and in the embodiment of FIG. 26, the function essential for the invention is achieved, that is, a gas jet emerging from the outlet duct 18 widens downstream of the outlet opening 16 and may even split into a plurality of partial jets.

1. A nozzle for gaseous media comprising a housing, an inlet, at least one outlet opening, wherein a border of the at least one outlet opening is defined by an intersection of an outlet portion of an outlet duct with a portion of an outer wall of the housing surrounding the at least one outlet opening, wherein the outlet duct is fluidly connected to the inlet, and wherein the border of the at least one outlet opening defines a beginning and an end of the outlet portion, the border of the at least one outlet opening spanning a non-planar outlet surface.

2. The nozzle according to claim 1, wherein the at least one outlet opening comprises in that at least five outlet openings in the housing.

3. The nozzle according to claim 2, wherein the at least five outlet openings have the same diameter, and a distance between two adjacent outlet openings is a maximum of ten times a diameter of the outlet openings.

4. The nozzle according to claim 1, wherein the at least one outlet opening comprises a plurality of outlet openings and all of the outlet surfaces are identical.

5. The nozzle according to claim 1, wherein the outlet surface is configured as a roof and is defined by a ridge line and two partial outlet surfaces, wherein the partial outlet surfaces start from the ridge line and are differently aligned at least in sections, and wherein the ridge line defines a maximum height of the outlet portion between the start and end of the outlet portion.

6. The nozzle according to claim 1, wherein the outlet surface comprises a channel and is defined by a trough line and two partial outlet surfaces, wherein the partial outlet surfaces start from the trough line and are differently aligned at least in sections, and wherein the trough line defines a maximum depth of the outlet portion between the start and end of the outlet portion.

7. The nozzle according to claim 1, wherein the outlet duct at a transition into the outlet portion has a free cross-sectional area arranged perpendicular to a flow direction, and a height or depth of the outlet portion is at least 15 per cent of a square root of a size of the cross-sectional area of the outlet duct.

8. The nozzle according to claim 1, wherein the outlet surface is curved.

9. The nozzle according to claim 8, wherein the outlet surface forms a cutout of a convexly or concavely curved cylinder surface.

10. The nozzle according to claim 1, wherein the outlet surface comprises at least two planar partial outlet surfaces, wherein the at least two of the partial outlet surfaces abut against one another at a ridge line or trough line and are arranged with respect to one another at an angle differing from 180 degrees.

11. The nozzle according to claim 10, wherein the outlet surface forms a cutout from a gable roof surface.

12. The nozzle according to claim 11, wherein a ridge line of the gable roof surface forms part of a convexly rounded ridge surface.

13. The nozzle according to claim 1, wherein the at least one outlet opening comprises a plurality of outlet openings arranged next to one another on an imaginary straight line.

14. The nozzle according to claim 13, wherein the plurality of outlet surfaces are aligned with one another.

15. The nozzle according to claim 12, wherein center lines of the outlet surfaces are arranged parallel to one another and at a distance of center longitudinal axes of the outlet ducts.

16. The nozzle according to claim 1, further including at least three of the outlet ducts, wherein, as seen perpendicular to an outflow direction, an angle of a center longitudinal axis of outer outlet portions to a center longitudinal axis of a middle outlet duct is greater than zero degrees.

17. The nozzle according to claim 16, further including at least five of the outlet ducts, wherein, as seen perpendicular to the outflow direction, an angle of the center longitudinal axes of the outer outlet portions to the center longitudinal axis of the middle outlet duct increases.

18. The nozzle according to claim 1, further including a plurality of the outlet openings, the plurality of outlet openings being arranged on an imaginary circular line lying within a plane.

19. The nozzle according to claim 1, wherein the at least one outlet duct, as seen in a flow direction from the inlet to the outlet opening, has a constant cross section, a decreasing cross section or a slightly expanding cross section.

20. The nozzle according to claim 19, wherein the outlet duct has a slightly expanding cross section, wherein a cross-sectional area of the outlet duct immediately before a transition of the outlet duct into the outlet portion is a maximum of 20% larger than a smallest cross-sectional area of the outlet duct.

21. The nozzle according to claim 1, wherein the at least one outlet opening comprises a plurality of outlet openings, wherein none of the plurality of outlet openings operates as a Laval nozzle.

22. The nozzle according to claim 1, wherein the inlet, the outlet duct and the outlet opening are configured and arranged such that, during supercritical operation of the nozzle at a positive pressure of 1 bar or more than 1 bar, a gas jet expands after passing through the outlet opening.

23. The nozzle according to claim 1, wherein a cross section of the outlet duct, as seen perpendicular to a flow direction, is circular.

24. The nozzle according to claim 1, wherein a cross section of the outlet duct is oval, polygonal, rectangular, square or hexagonal, wherein a maximum width and a maximum height of the outlet duct have, at maximum, a ratio of 1 to 5.

25. The nozzle according to claim 1, wherein each outlet duct and each outlet opening are formed in an integral portion of the housing of the nozzle.

26. A method for operating a nozzle according to claim 1, wherein the nozzle is operated in the supercritical range at a positive pressure of the gaseous medium of 1 bar or more than 1 bar, such that a medium jet emerging from the at least one outlet opening widens after passing through the outlet opening.
